(19) United States
(12) Patent Application Publication
(10) Pub. No.: US 2003/0236954 A1
(43) Pub. Date: Dec. 25, 2003

(54) Method for configurable priority read order of mirrors from within a volume manager

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/177,846

(22) Filed: Jun. 20, 2002

(51) Int. Cl. G06F 12/00

(52) U.S. Cl. 711/158; 711/114

(57) ABSTRACT

A method, program, and system for prioritizing data read operations are provided. The invention comprises prioritizing a plurality of storage drives that contain duplicate data, and, responsive to a read request, reading data from the highest priority storage drive among the plurality of storage drives. If the highest priority drive is unavailable, or if the read operation is unsuccessful, data is read from the next highest priority drive that is available. The drive can be distributed over a network, with priority determined according to proximity to a given user.

### BACKGROUND OF THE INVENTION

1. Technical Field

The present invention relates generally to data mirroring, and more specifically to a method for prioritizing the read order of mirrors during data recovery.

2. Description of Related Art

Within a Redundant Array of Independent Disks (RAID) storage system, users create volumes for physical data storage across a collection of drives. Volumes created on the same set of drives are grouped into an array called a volume group. The volume group is assigned a specific RAID level by the user, which defines how the data will be striped across the set of drives and what kind of redundancy scheme is used. RAIDs are used to increase performance and/or increase reliability.

One use of RAID systems is mirroring, which comprises duplicating data onto another computer at another location, or in closer proximity to the user. This provides complete redundancy and the highest level of reliability. Remote mirrors are one solution for disaster recovery of persistent disk data.

Mirrored write operations are not special, because the system cannot signal to the requester that the write is complete before all mirrors have completed writing. However, mirrors are not created equal for read operations. If a user reads at random from any mirror, that user will, on average, read from some remote mirror half the time. Thus, the read will take longer than it would from a local mirror.

Therefore, it would be desirable to have a method for prioritizing mirror read operations according to proximity and/or speed.

### SUMMARY OF THE INVENTION

The present invention provides a method, program, and system for prioritizing data read operations. The invention comprises prioritizing a plurality of storage drives that contain duplicate data, and, responsive to a read request, reading data from the highest priority storage drive among the plurality of storage drives. If the highest priority drive is unavailable, or if the read operation is unsuccessful, data is read from the next highest priority drive that is available. The drive can be distributed over a network, with priority determined according to proximity to a given user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a diagram illustrating a RAID system volume group containing multiple volumes, in which the present invention may be implemented;

FIG. 5 depicts a schematic diagram illustrating a RAID system in accordance with the present invention;

FIG. 6 depicts a flowchart illustrating the process of setting mirror read priorities in accordance with the present invention; and

FIG. 7 depicts a flowchart illustrating I/O processing according to mirror priority in accordance with the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

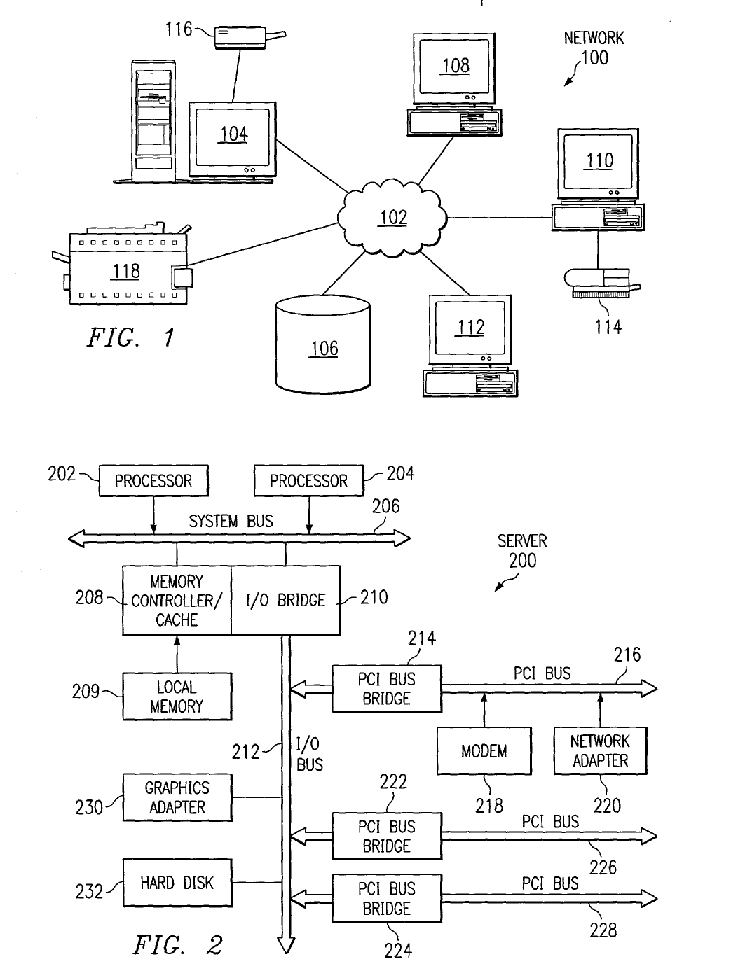

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

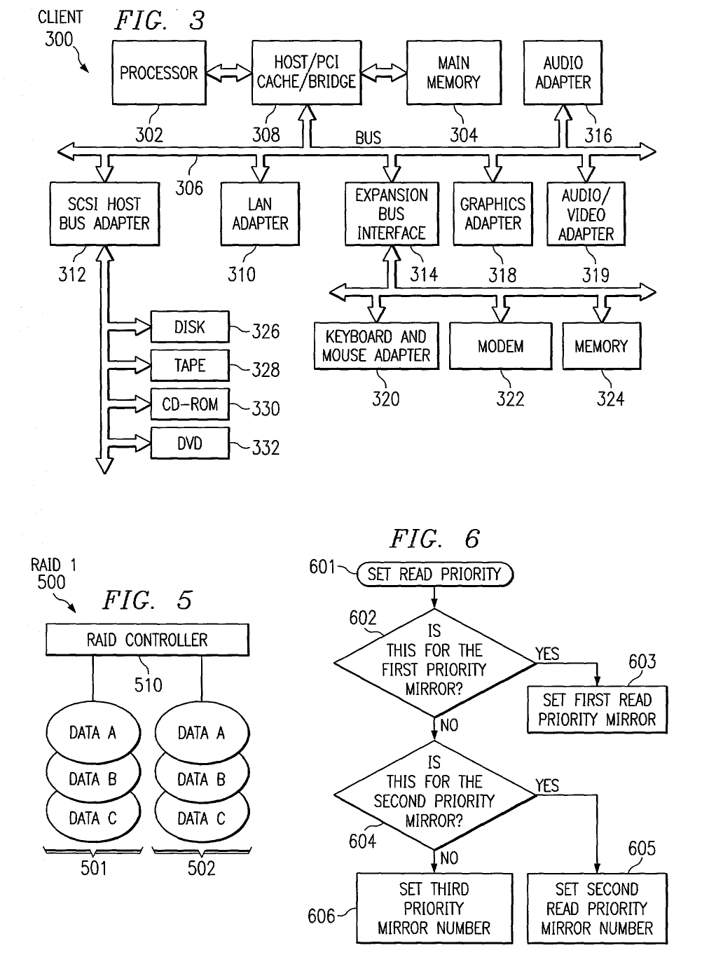

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

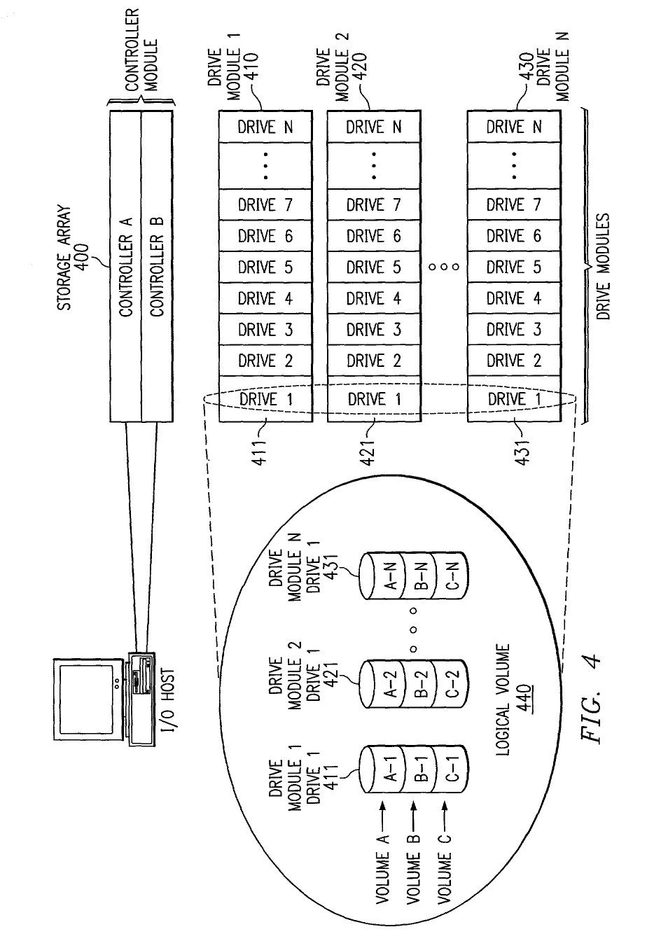

FIG. 4 depicts a diagram illustrating a RAID system volume group containing multiple volumes, in which the present invention may be implemented. The RAID storage system 400, is divided into multiple (n) drive modules 1 (410) through n (430), each of which in turn comprises multiple (n) storage drives. Users can create volumes for physical data storage across a collection of drives. For example, in FIG. 4, the data in volume A is divided into n sections (n being equal to the number of drive modules) and each section is stored on the first respective drive in each drive module. Therefore, section A-1 is stored on Drive 1 411 in Module 1 410, section A-2 is stored on Drive 1 421 in Module 2 420, and section A-n is stored on Drive 1 431 in Module n 430.

Furthermore, multiple volumes created on the same set of drives (e.g., the first respective drives in each module) are grouped into an entity called a volume group. In FIG. 4, volume group 440 comprises three volumes A, B and C. Building on the example above, sections A-1, B-1, and C-1 are stored on Drive 1 411 in Module 1 410, sections A-2, B-2, and C-2 are stored on Drive 1 421 in Module 2 420, etc. As a further example, a second volume group, e.g., volumes D, E and F, might be stored on the second respective drives in each module. The volume group is the equivalent of a physical disk from the system's point of view. The logical volume is the equivalent of partitions into which this storage space is divided for creating different filesystems and raw partitions.

The logical volume is assigned a specific RAID level by the user, which defines how the data will be striped across the set of drives and what kind of redundancy scheme is used (explained in more detail below). Any remaining capacity on a volume group can be used to create additional volumes or expand the capacity of the existing volumes.

The Logical Volume Manager (LVM) creates a layer of abstraction over the physical storage. Applications use virtual storage, which is managed by the LVM. The LVM hides the details about where data is physically stored from the entire system (i.e. on which actual hardware and where on that hardware). Volume management allows users to edit the storage configuration without actually changing anything on the hardware side, and vice versa. By hiding the hardware details, the LVM separates hardware and software storage management, making it possible to change the hardware side without the software ever noticing, all during runtime.

Referring to FIG. 5, a schematic diagram illustrating a RAID system is depicted in accordance with the present invention. RAID 1 500 uses mirroring, which provide 100% duplication of data (A, B, and C) on two drives 501 and 502 that are controlled by a common RAID controller 510. This provides complete redundancy and the highest level of reliability. Mirroring can comprise duplicating data onto another computer at another location, or in closer proximity to the user.

Hardware RAID works such as RAID 500 on a very low device level and is bound to a specific controller and storage subsystem. It safeguards against failures of one or more (depending on what the RAID configuration is) drives within one storage system, and/or to increase throughput.

Logical volume management can also provide certain RAID functions like striping or mirroring but works independent of any particular storage system. LVM has the ability to do things that go beyond what the particular hardware controller in a RAID could do. For example, if a database server needs more space for one of its tablespaces, the administrator would add another drive to the RAID array using the proprietary software provided by the RAID manufacturer. But this is not possible if that array is already full. With LVM, it is possible to add a disk anywhere in the system. The new disk can be put into a free slot on another RAID controller and added to the volume group containing the tablespace. The logical volume used by the tablespace can be resized to use the new space in the volume group, and the operator of the database can be told to extend that tablespace.

RAID arrays come with software that is limited to the storage hardware, i.e. the RAID array, and cannot do anything else. The LVM on the other hand is independent of any proprietary storage system and treats everything as “storage”. Thus, all the storage (all Logical Volumes and Volume Groups) can be moved from one physical array to the next.

The present invention provides a method for prioritizing local and remote mirrors with respect to any given machine for disaster recovery purposes. All mirrors are given a priority ordering so that the best mirror (fastest, nearest, etc.) is read from first, the next best if the first fails, and so on. This ordering is customized so that every machine that has access to the volume group has its own priority order. The priority for each machine may be set manually by an administrator. Alternatively, the priority is established automatically via inputs from a SAN management application, which can take SAN conditions into account when setting the priority order for any given locality. While the present invention can be used with either a RAID or LVM, it has greater applicability to LVM.

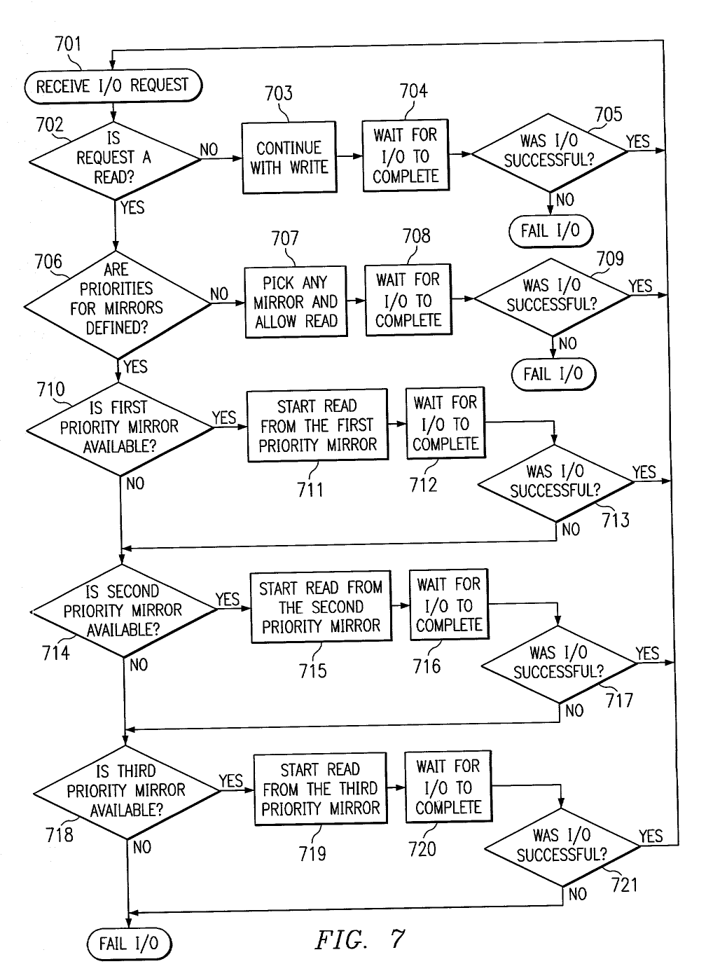

Referring now to FIG. 6, a flowchart illustrating the process of setting mirror read priorities is depicted in accordance with the present invention. When the administrator enters the command to set read priorities (step 601), the LVM determines if the priority is for the first priority mirror (step 602). If it is, the LVM sets the first read priority mirror (step 603).

If the priority is not for the first priority mirror, the LVM determines if it is for the second priority mirror (step 604). If the priority is for the second priority mirror, then the LVM sets the second read priority mirror number (step 605). If the priority is not for the second mirror, the LVM sets the third priority mirror number (step 606). For ease of illustrating, this example only assumes three mirrors in the volume group. However, the number of mirrors can be less than or greater than three.

Referring to FIG. 7, a flowchart illustrating I/O processing according to mirror priority is depicted in accordance with the present invention. When an I/O request is received (step 701), the first step is to determine if the I/O is a read or write operation (step 702). If the I/O is a write, the system continues with the write (step 703) until the I/O comes to completion (step 704). The system then determines if the I/O (write) was successful (step 705). If the write was successful, the process returns and waits for the next I/O request. If the write was not successful, the I/O fails.

If the I/O is a read, the system determines if priorities are defined for the available mirrors (step 706). If there are no set priorities, the system will pick any of the available mirrors and allows the read to proceed (step 707). When the I/O completes (step 708), the system determines if the read was successful or not (step 709). If the read was successful, the process returns and waits for the next I/O request. If the read was not successful, the I/O fails.

If mirror priorities have been set, the system determines if the first priority mirror is available (step 710). If it is, the system starts reading from the first priority mirror (step 711), waits until the read completes (step 712), and determines if the read was successful (step 713). If the read was successful, the process returns to wait for the next I/O request.

If the read from the first priority mirrors is not successful, or if the first priority mirror is not available, the system determines if the second priority mirror is available (step 714). If the second priority mirror is available, then the system reads from that disk (step 715), waits for the read to finish (step 716) and determines if the read was successful (step 717). Again, if the read is successful, the process returns to the beginning and waits for the next I/O request.

If the read from the second priority mirror is not successful, or if the second priority mirror is not available, the system determines if the third priority mirror is available (step 718). If the third priority mirror is available, the systems reads from that mirror (step 719), waits until the read is compete (step 720), and determines if the read was successful (step 721). If the read was successful, the process returns to the beginning and waits for the next for the next I/O request. If the third priority mirror is not available, or the read from the third priority mirror is not successful, the I/O fails. Again, this example assumes that the system has three mirrors. A different number of mirrors may also be used.

Applying the present invention to a concrete example, a volume group might have 30 mirrors. The local mirror is in Austin, Tex., and the remaining 29 mirrors are spread around the world. If data recovery is necessary, the local mirror in Austin is the first one read. If there is a disk failure in Austin, the San Antonio mirror is read next, then Denver, then Las Vegas, etc. Building on the same example, if Austin has a flood and goes down, Denver might take over, and the Denver mirror becomes the local mirror. Therefore, Denver would now be the first mirror, and Las Vegas would be the next closest mirror should the Denver disk fails, etc.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for prioritizing data read operations, the method comprising the computer-implemented steps of:
prioritizing a plurality of storage drives that contain duplicate data; and
responsive to a read request, reading data from the highest priority storage drive among the plurality of storage drives.

2. The method according to claim 1, wherein the data is organized into logical volumes by a logical volume manager.

3. The method according to claim 1, further comprising:
if the highest priority storage drive is unavailable, reading data from the next highest priority storage drive available among the plurality of storage drives.

4. The method according to claim 1, further comprising:
if data read from the highest priority storage drive is unsuccessful, reading data from the next highest priority storage drive available among the plurality of storage drives.

5. The method according to claim 1, wherein the plurality of storage drives comprise a logical volume group.

6. The method according to claim 1, wherein the plurality of storage drives comprise a redundant array of independent disk (RAID).

7. The method according to claim 1, wherein the plurality of storage drives are distributed over a computer network.

8. The method according to claim 7, wherein the plurality of storage drives are prioritized according to proximity to a given user.

9. A computer program product in a computer readable medium for use in a data processing system, for prioritizing data read operations, the computer program product comprising:
first instructions for prioritizing a plurality of storage drives that contain duplicate data; and
second instructions, responsive to a read request, for reading data from the highest priority storage drive among the plurality of storage drives.

10. The computer program product according to claim 9, wherein the data is organized into logical volumes by a logical volume manager.

11. The computer program product according to claim 9, further comprising:
third instructions, if the highest priority storage drive is unavailable, for reading data from the next highest priority storage drive available among the plurality of storage drives.

12. The computer program product according to claim 9, further comprising:
fourth instructions, if data cannot be read successfully from the highest priority storage drive, for reading data from the next highest priority storage drive available among the plurality of storage drives.

13. The computer program product according to claim 9, wherein the plurality of storage drives comprise a logical volume group.

14. The computer program product according to claim 9, wherein the plurality of storage drive are distributed over a computer network.

15. The computer program product according to claim 14, wherein the plurality of storage drives are prioritized according to proximity to a given user.

16. A system for prioritizing data read operations, the system comprising:
a ranking component for prioritizing a plurality of storage drives that contain duplicate data; and
a data recovery component, responsive to a read request, for reading data from the highest priority storage drive among the plurality of storage drives.

17. The system according to claim 16, wherein the data is organized into logical volumes by a logical volume manager.

18. The system according to claim 16, further comprising:
a second data recover component, if the highest priority storage drive is unavailable, for reading data from the next highest priority storage drive available among the plurality of storage drives.

19. The system according to claim 16, further comprising:
a third data recovery component, if data cannot be read successfully from the highest priority storage drive, for reading data from the next highest priority storage drive available among the plurality of storage drives.

20. The system according to claim 16, wherein the plurality of storage drives comprise a logical volume group.

21. The system according to claim 16, wherein the plurality of storage drives comprise a redundant array of independent disk (RAID).

22. The system according to claim 16, wherein the plurality of storage drive are distributed over a computer network.

23. The system according to claim 22, wherein the plurality of storage drive are prioritized according to proximity to a given user.
